(19) United States
(12) Patent Application Publication
(10) Pub. No.: US 2026/0094537 A1
(43) Pub. Date: Apr. 2, 2026

(54) SIMULATION DEVICE AND METHOD

(71) Applicant: University of Rochester, Rochester, NY (US)

(72) Inventors: Ariana Goodman, Rochester, NY (US); Andrew Jones, Rochester, NY (US); Kyle Purrman, Rochester, NY (US)

(21) Appl. No.: 19/345,167

(22) Filed: Sep. 30, 2025

Related U.S. Application Data
(60) Provisional application No. 63/701,031, filed on Sep. 30, 2024.

(51) Int. Cl. G09B 23/28

(52) U.S. Cl. CPC G09B 23/285

(57) ABSTRACT

Aspects of the present invention relate to a device with a container consisting of a base with one or more sidewalls extending upwards from the base forming a top opening, and one or more openings passing through at least one of the sidewalls, one or more conduits each having a first end and a second end configured to simulate one or more blood vessels, wherein each conduit at least partially extends through the container, and wherein a portion of at least one end of each conduit extends out from the container through the one or more openings, wherein the container is at least partially filled with one or more tissue simulants, and the one or more conduits are at least partially filled with a blood simulant. A method of simulating an endovascular procedure using a device is also disclosed.

### CROSS-REFERENCE TO RELATED APPLICATIONS

This application claims priority to U.S. Provisional Application No. 63/701,031, filed on Sep. 30, 2024, incorporated herein by reference in its entirety.

### BACKGROUND OF THE INVENTION

Healthcare personnel require training with hands-on practical experience for performing endovascular procedures on patients. This relates to both the training of new personnel such as in surgical residency programs, as well as the continued education of existing personnel. There are over 100 thoracic surgery training programs nationwide, with nearly 500 thoracic surgery trainees. When including general surgery residents, vascular surgery residents, interventional radiology residents, and anesthesia residents, this includes nearly 900 programs nationwide, with over 18,000 trainees who will need to be trained and retrained on a regular basis on endovascular procedures. Further, the process of identifying, and then cannulating large vessels is becoming increasingly relevant in a widening variety of medical specialties including pre-hospital and military care.

Healthcare personnel require training and repeated practice with the tactile, hands on steps associated with endovascular procedures such as large vessel cannulation. One such procedure includes extracorporeal membrane oxygenation (ECMO) cannulation which necessitates accessing the femoral artery and vein of a patient. The training for this time-critical, sterile procedure should provide the ability to practice the mechanical and technical skills of performing the procedure (e.g., vessel cannulation, ECMO cannulation) under repeatable and sterile conditions without fear of contaminating a patient. Simulation also allows the various team members including doctors and nurses, to practice the procedure together and debrief to improve efficiency and safety in the future.

While small scale devices or models of arteries and veins exist for vessel identification and needle access, these are limited in their size and ability to be cannulated. They do not allow large diameter cannulae, nor do they feature anatomical landmarks in the same way the human body does. These devices are designed for peripheral vascular access, and thus do not prioritize the tactile feedback associated with large vessel central artery and venous access. Other models of extracorporeal membrane oxygenation (ECMO) exist, but are integrated into larger humanoid manikins, and are prohibitively expensive, disallowing trainees to repeat the necessary repetitions of this very tactile, hands on procedure before moving to live patients.

Thus there is the need in the art for adaptable simulation devices for healthcare personnel and trainees to develop and hone their skills. The present invention meets this need.

### SUMMARY OF THE INVENTION

Aspects of the present invention relate to a simulation device with a container having a first end and a second end consisting of a base with one or more sidewalls extending upwards from the base forming a top opening, and one or more openings passing through at least one of the sidewalls, one or more conduits each having a first end and a second end configured to simulate one or more blood vessels, wherein each conduit extends from the first end of the container to the second end of the container, and wherein a portion of at least one end of each conduit extends out from the container through the one or more openings, wherein the container is at least partially filled with one or more tissue simulants, and at least one of the one or more conduits are at least partially filled with a blood simulant.

In some embodiments, the one or more blood vessels are selected from the group consisting of femoral artery, femoral vein, subclavian artery, subclavian vein, jugular vein, radial artery, axillary artery, carotid artery, median cubical vein, basilic vein, and cephalic vein. In some embodiments, the one or more conduits comprise a first conduit and a second conduit, wherein the first conduit has a diameter that is different from the diameter of the second conduit. In some embodiments, the one or more conduits comprise a first conduit configured to simulate a femoral artery, and a second conduit configured to simulate a femoral vein.

In some embodiments, the device includes one or more anatomical simulants positioned in the container configured to simulate one or more anatomical landmarks. In some embodiments, the one or more anatomical landmarks are selected from the group consisting of vascular landmarks, bony landmarks, soft tissue landmarks, muscular landmarks, bony structure, vasculature, vascular bifurcations/branches, soft tissue, soft tissue structures, echo-lucent soft tissue structures, ligamentous landmarks, inguinal ligament, the bifurcation of the common femoral artery, the femoral sheath, the bifurcation of the innominate artery into the subclavian, the brachiocephalic trunk, the pleural space, the clavicle, the ribs, the radius, the ulna, nerves, the brachial plexus nerves, lymph nodes, lymphatic structures.

In some embodiments, the one or more tissue simulants are selected from the group consisting of gel, hydrogel, transparent gel, ultrasound transparent gel, ballistic gel, crosslinked polymer, gelatinous substance, gelatin, silicone, polyurethane, liquid suspension, and elastomer. In some embodiments, the one or more tissue simulants is dyed or tinted with one or more dyes or tints. In some embodiments, the blood simulant is selected from the group consisting of artificial blood, water, dyed water, red dyed water.

In some embodiments, the one or more conduits comprise a flexible and puncturable tubing formed from one or more materials selected from the group consisting of polymer, latex, rubber, silicone, silicone rubber, thermoplastic elastomer (TPE), thermoplastic polyurethane (TPU), continuous liquid interface production (CLIP) resin, and 3D printed material.

In some embodiments, the device includes at least one blood simulant supply connected to the first end of the one or more conduits. In some embodiments, the device includes a syringe or valve connected to the second end of the one or more conduits.

In some embodiments, the device includes one or more storage compartments releasably attached to at least one of the ends the container.

In some embodiments, the container has a length ranging between 10 cm and 60 cm, a width ranging between 5 cm and 40 cm, and a height ranging between 5 cm and 20 cm. In some embodiments, the container has an interior volume ranging between 250 cm³ and 32,000 cm³.

In some embodiments, the container is at least partially formed in one or more shapes, wherein the shapes are selected from the group consisting of oblong, rectangle, oval, square, circle, polygon, hexagon, octagon, and irregular.

Aspects of the present invention relate to a simulation kit, including any disclosed simulation device (e.g., a simulation device, any disclosed device), one or more endovascular tools (e.g., may be positioned or stored in the one or more compartments of the device), and a blood simulant supply.

In some embodiments, the one or more endovascular tools are selected from the group consisting of needle, cannula, ECMO cannula, catheter, guide wire, pump, balloon and dilator.

In some embodiments, the kit includes at least one of a tissue simulant supply, one or more valves, one or more connectors, one or more vascular access needles, and one or more syringes.

Aspects of the present invention relate to a method of simulating an endovascular procedure having the steps of providing a simulation device (e.g., a simulation device, any disclosed device), providing one or more endovascular tools, simulating one or more endovascular procedures with the device and the one or more endovascular tools.

In some embodiments, the step of simulating one or more endovascular procedures includes the steps of identifying the one or more simulated blood vessels, and cannulating the one or more simulated blood vessels with the one or more endovascular tools. In some embodiments, the method includes the step of advancing one or more guidewires or dilators into the one or more simulated blood vessels. In some embodiments, the cannulating step comprises advancing fully one or more extracorporeal membrane oxygenation (ECMO) cannula into the appropriate one or more simulated blood vessels.

Aspects of the present invention relate to a method a method of fabricating a simulation device having the steps of providing a container comprising a base with one or more sidewalls extending upwards from the base forming a top opening, and one or more holes passing through at least one of the sidewalls, providing one or more conduits having first end and a second end, wherein the one or more conduits is formed from at least one flexible and puncturable material, positioning the one or more conduits to pass through the container with at least one end extending out through at least one of the one or more holes, configuring the one or more conduits to simulate one or more blood vessels, filling the container at least partially with one or more tissue simulants, filling the one or more conduits with a blood simulant.

In some embodiments, the step of configuring the one or more conduits to simulate one or more blood vessels includes the steps of providing one or more shaping structures configured to removably reside within the one or more conduits during the step of filling the container, shaping the one or more conduits to simulate one or more blood vessels. In some embodiments, the step of providing one or more conduits comprises 3D printing the one or more conduits in the size and shape of one or more blood vessels. In some embodiments, the method further includes placing one or more anatomical landmarks or structures in the container during the step of filling the container.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 is an image depicting a front perspective view of an exemplary simulation device comprising a container (to be filled with a tissue simulant or gel) with removable compartments, and one or more conduits extending through the container simulating vessels in a subject.

FIG. 2 is an image depicting a right perspective view of the simulation device of FIG. 1 showing a first compartment removably attached to the container comprising integrated storage space and retainment mechanisms for the one or more conduits.

FIG. 3 is an image depicting a front perspective view of the simulation device of FIG. 1 with the one or more conduits deployed and extending out from one side of the device.

FIG. 4 is an image depicting a front perspective view of the simulation device of FIG. 1 showing a second compartment detached exposing the second ends of the one or more conduits.

FIG. 5 is an image depicting a front perspective view of an exemplary simulation device comprising a container filled with a tissue simulant (e.g., a gel insert) and one or more conduits extending through the container and tissue simulant.

FIG. 6 is an image depicting the simulation device of FIG. 1 showing connectors and valves on the second ends of the one or more conduits, and sharps storage and directional labelling in the top surface of the second compartment.

FIG. 7 is an image depicting a user performing a simulated endovascular procedure using an exemplary simulation device with a full-size 25 Fr extracorporeal membrane oxygenation (ECMO) Cannula.

FIG. 8 is a diagram depicting an exemplary method of simulating an endovascular procedure according to aspects of the present invention.

### DETAILED DESCRIPTION

It is to be understood that the figures and descriptions of the present invention have been simplified to illustrate elements that are relevant for a clear understanding of the present invention, while eliminating, for the purpose of clarity many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, exemplary materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate.

The terms “patient,” “subject,” “individual,” and the like are used interchangeably herein, and refer to any animal amenable to the systems, devices, and methods described herein. The patient, subject or individual may be a mammal, and in some instances, a human.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Simulation Device and Kit, Methods of Use, and Fabrication Methods

The disclosed simulation device and method (in some examples referred to as “CannuSim” or a “simulation tool”) can be used to model a portion of a subject and simulate endovascular procedures providing a simple and effective training tool for healthcare personnel and trainees. Generally, the disclosed simulation device comprises a container filled with a tissue simulant and one or more conduits simulating blood vessels extending through the container and tissue simulant. In some embodiments, the tissue simulant is a gel or similar material providing a medium to affix and/or position the one or more conduits within the container. In some embodiments, the one or more conduits are formed of flexible and/or puncturable tubing that may be connected to connectors, valves, syringes, fluid supplies (e.g., a blood simulant supply), and the like. In some embodiments, the one or more conduits are configured to simulate specific blood vessels in a subject (e.g., the bifurcation of the femoral vessels). Further, in some embodiments, one or more anatomical landmarks are positioned in the container (e.g., bony or vascular anatomical structures positioned within the tissue simulant). In some embodiments, the device comprises removable compartments for storing the conduits and providing ergonomic features such as sharps storage or labelling. In some embodiments, the disclosed device may be incorporated into a simulation kit with endovascular tools, simulants (e.g., tissue and blood simulant) and anatomical landmarks (e.g., 3D printed bony structures).

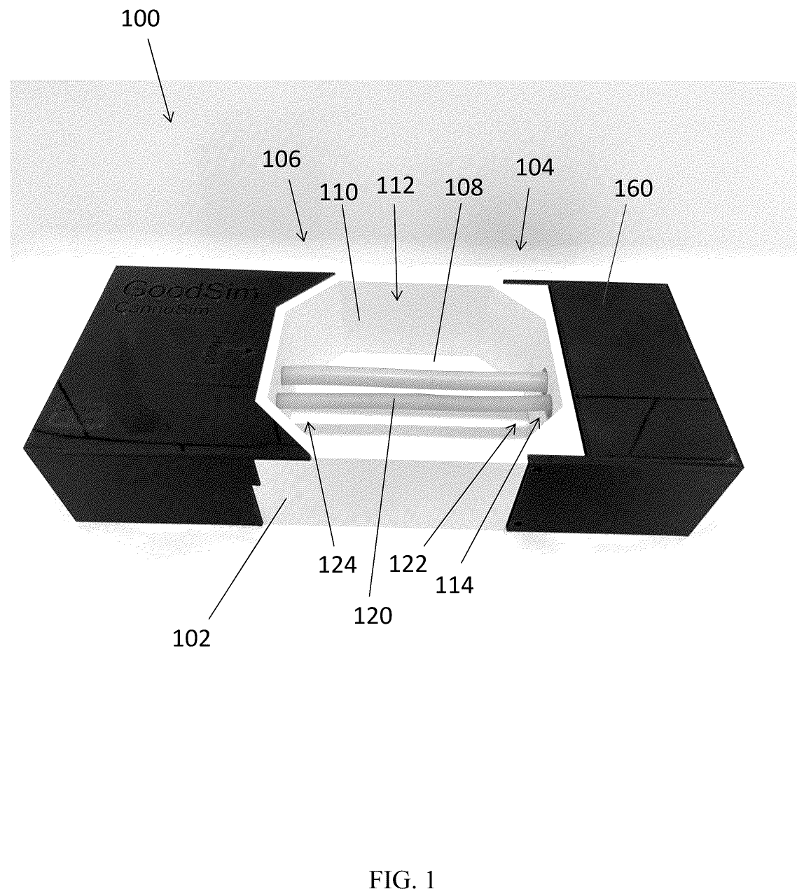

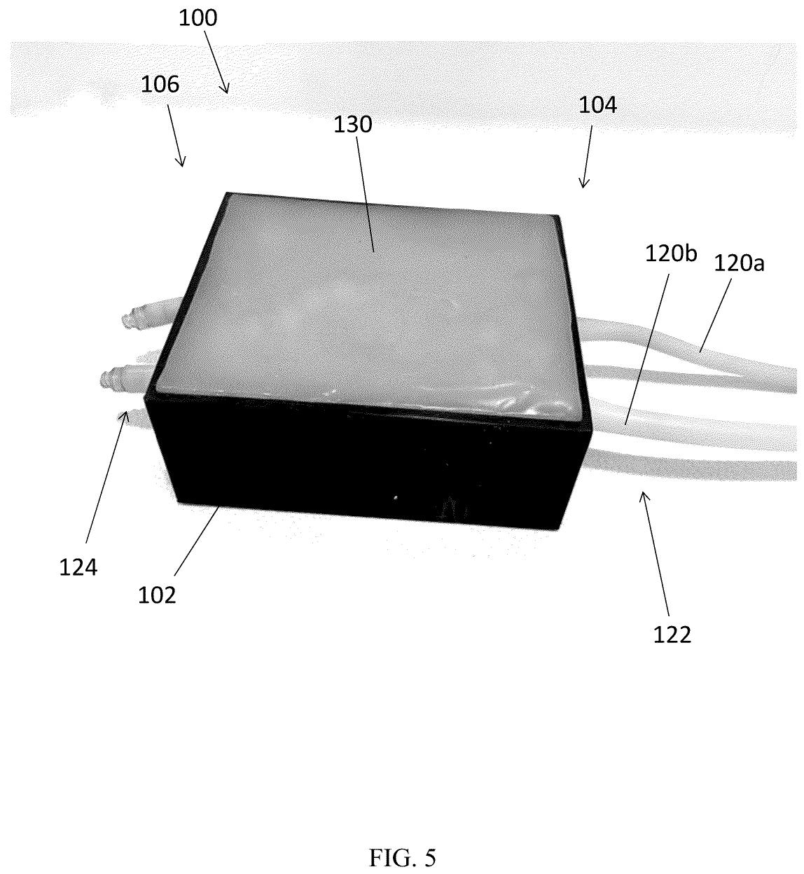

Referring now to FIG. 1, shown is an exemplary simulation device 100 according to aspects of the present invention. In some embodiments, device 100 comprises at least one container 102 having a first end 104 and a second end 106 formed by a base 108 with and one or more sidewalls 110 extending upwards from the base forming a top opening 112. Generally, container 102 has one or more openings 114 or holes passing through the sidewalls 110 that are sized and shaped for the one or more conduits 120 to extend through. For example, in some embodiments, container 102 comprises one or more openings 114 in one or more sidewalls 110 in first end 104, and one or more openings 114 in one or more sidewalls 110 of second end 106, or a first set of openings in first end 104, and a second set of openings in second end 106. Although exemplary arrangements for the one or more openings 114 are provided, it should be appreciated that any number of openings 114 may be formed in any number and positions of the one or more sidewalls 110. Container 102 may be formed of any suitably rigid material to hold or retain a tissue simulant (e.g., tinted or dyed ballistic gel, see FIG. 5). In some embodiments, device 100 further comprises one or more compartments 160 that may be removably attached to container 102.

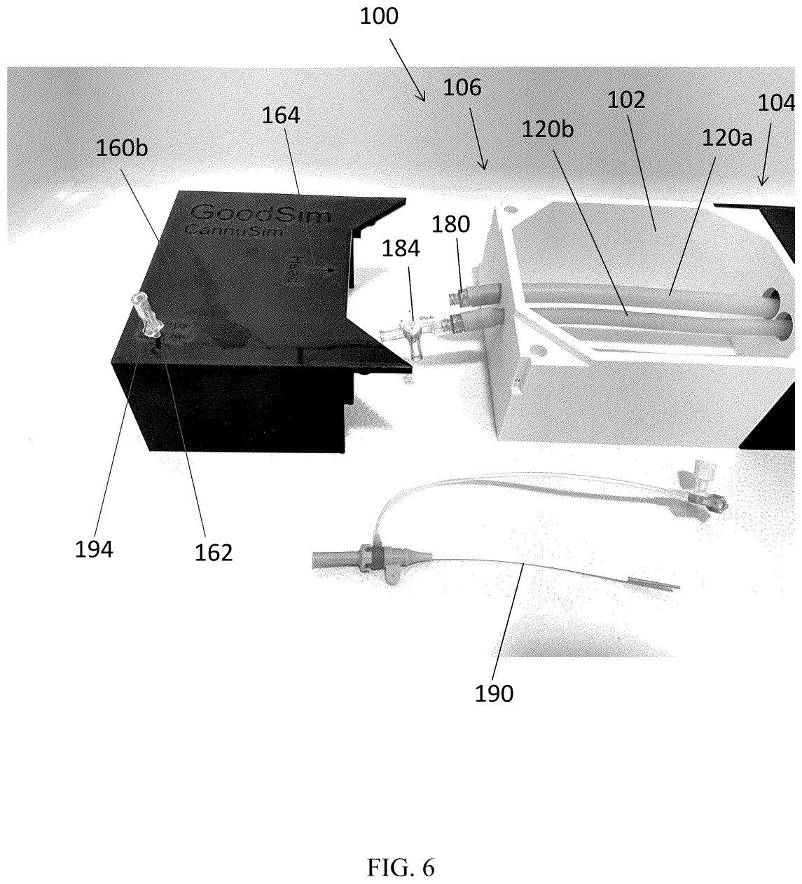

Aspects of the present invention relate to one or more conduits 120 for device 100. In some embodiments, device 100 comprises one or more conduits 120 each having a first end 122 and a second end 124 and configured to simulate one or more blood vessels. In some embodiments, the one or more conduits 120 extend from a position near or at first end 104 to a position near or at second end 106 of container 102. In some embodiments, at least a portion of at least one end (e.g., first end 122, second end 124) of the one or more conduits 120 extends out from container 102 through the one or more openings 114. In some embodiments, both first end 122 and second end 124 of each conduit extends out from container 102 through the one or more openings 114. The one or more conduits 120 may be formed of any suitable flexible and puncturable lumened structure or material (e.g., tubing) to mimic or simulate one or more blood vessels in a subject. In some embodiments, the one or more conduits 120 are at least partially filled with a blood simulant 140 (See FIG. 6).

Aspects of the present invention relate to simulating or modelling one or more blood vessels in a portion or region of a subject using device 100. For example, in some embodiments, device 100 simulates or models one or more blood vessels selected from the group consisting of femoral artery, femoral vein, subclavian artery, subclavian vein, jugular vein, radial artery, axillary artery, carotid artery, median cubical vein, basilic vein, and cephalic vein. Various aspects of device 100 may be modified to simulate or model vessels and regions of a subject, including the size and shape of container 102, the tissue simulant (e.g., type, layers, density, color), the size, shape, position and path of the one or more conduits 120, and placing one or more anatomical landmarks within the container 102, as described further herein.

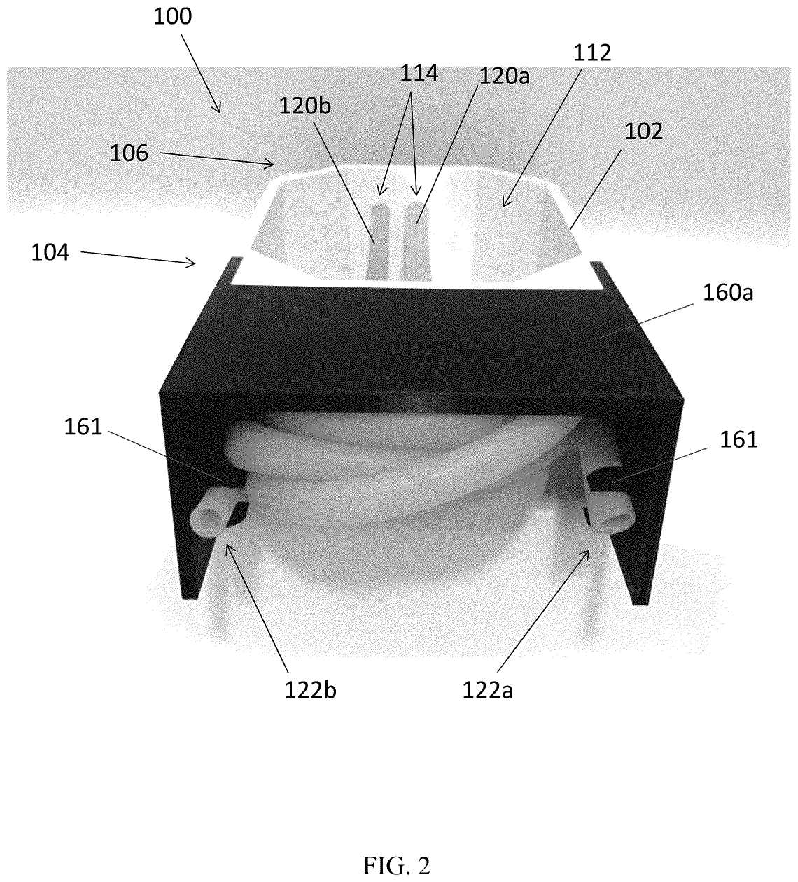

Referring now to FIGS. 2-4, shown are various views of an exemplary simulation device 100 comprising first and second conduits (120a, 120b) extending through an exemplary container 102 having first and second compartments (160a, 160b) removably attached thereto. The one or more conduits 120 may be sized and/or shaped the same, or differently. In some embodiments, first conduit 120a is sized and/or shaped differently from second conduit 120b. For example, in some embodiments, first conduit 120a has a larger inner or outer diameter compared to second conduit 120b, or smaller. In some embodiments, the one or more conduits 120 are configured to simulate or mimic the bifurcation of the femoral vessels. For example, in some embodiments, first conduit 120a is configured to simulate a femoral vein, and second conduit 120b is configured to simulate a femoral artery. In some embodiments, the one or more conduits 120 are configured to simulate or model typical vessels used for venipuncture by a phlebotomist, such as the median cubical, basilic and cephalic veins, or the subclavian or jugular veins, or the femoral artery, femoral vein, subclavian artery, radial artery, axillary artery, and carotid artery. Although exemplary vessels and/or regions of a subject are described, it should be appreciated that device 100 can be configured to model any vessels and/or regions of a subject.

Aspects of the present invention relates to materials and properties for the one or more conduits 120. In some embodiments, the one or more conduits 120 comprise a flexible and puncturable tubing formed from one or more materials. In some embodiments, the one or more conduits 120 are formed from or comprise one or more materials selected from the group consisting of polymer, latex, rubber, silicone, silicone rubber, thermoplastic elastomer (TPE), thermoplastic polyurethane (TPU), continuous liquid interface production (CLIP) resin, and 3D printed material.

In some embodiments, device 100 comprises one or more compartments 160 or containers removably or releasably attached or affixed to container 102. In some embodiments, device 100 comprises first and second compartments (160a, 160b) removably attached to an end of container 102. For example, in some embodiments, device 100 comprises a first compartment 160a configured to removably attach to first end 104 of container 102, and a second compartment 160b configured to removably attach to the second end 106.

Referring now to FIG. 2 in detail, shown is a side view of an exemplary simulation device 100 displaying the first ends (122a, 122b) of first and second conduits (120a, 120b) stored and/or retained in a first compartment 160a. In some embodiments, the one or more compartments 160 comprise one or more conduit retaining portions 161, configured to retain or store a portion of the one or more conduits 120. In some embodiments, the one or more conduit retaining portions 161 comprise any of clips, clamps, c-clip, c-clamp, hangers, brackets, racks, straps, spools, and any combinations thereof.

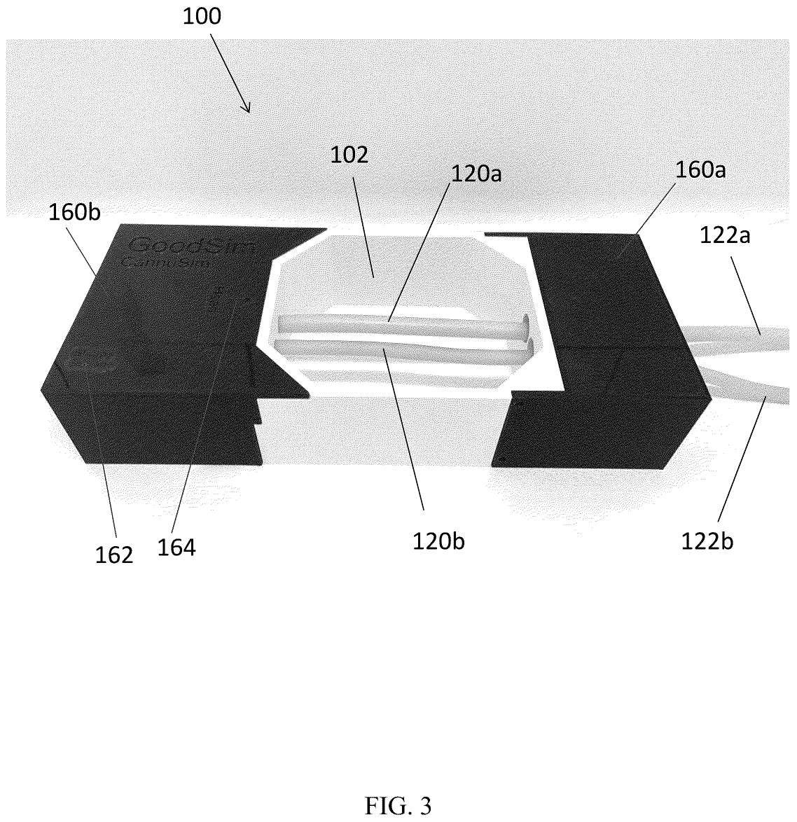

Referring now in detail to FIG. 3, in some embodiments, the one or more compartments 160 comprise a sharps storage feature 162 or labels 164 on a portion of the compartment. For example, in some embodiments, sharps storage feature 162 comprises an opening in a top surface of second compartment 160b, configured to retain sharps (e.g., a needle). In some embodiments, labels 164 comprise directional arrows, anatomical feature or position directional arrow (e.g., head orientation label), indexing labels, instructions labels, and any combinations thereof. FIG. 6 depicts a needle 194 being stored in sharps storage feature 162.

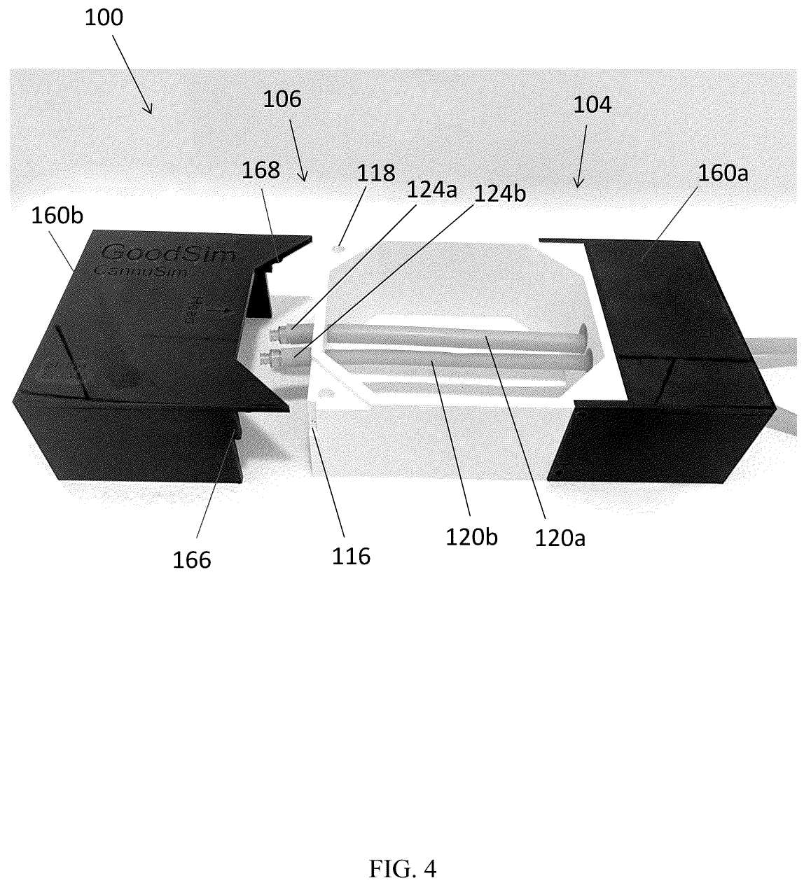

Referring now in detail to FIG. 4, in some embodiments, the one or more compartments 160 and/or container 102 comprise one or more attachment mechanisms or features. For example, in some embodiments, container 102 comprises a slot 116 and an indent 118 configured to removably interface with a tab 166 and detent 168, respectively, the tab 166 and detent 168 positioned on at least one of the one or more compartments 160. The one or more compartments 160 may be removably affixed or attached to container 102 with any method or mechanism known in the art including but not limited to, friction fit, compression fit, ball and detent, indent and detent, tongue and groove, tab and slot, locking mechanism, latch, sliding tab, locking tab, and any combinations thereof.

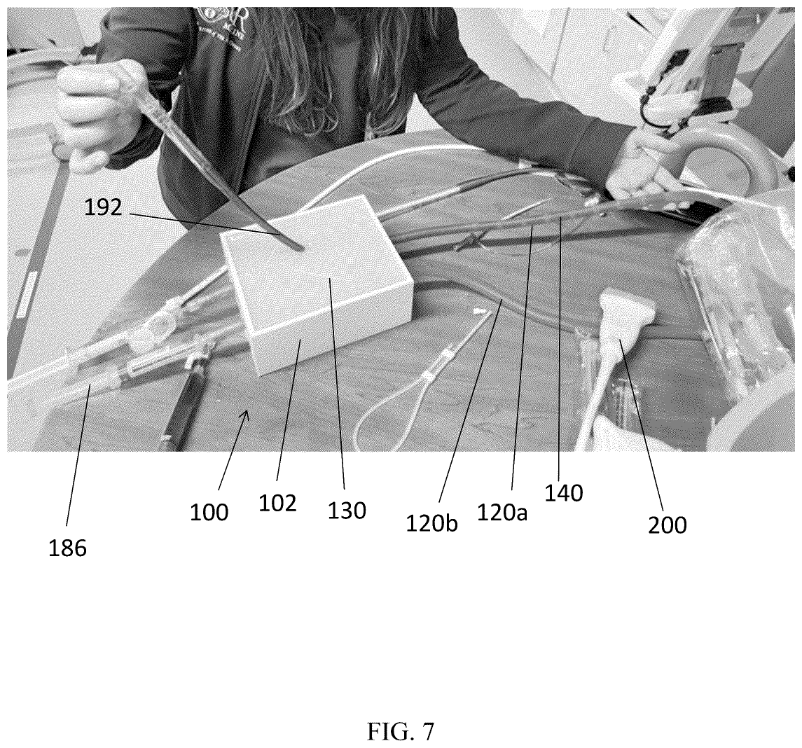

Aspects of the present invention relate to filling, positioning and/or retaining one or more tissue simulants 130 in container 102 of device 100. In some embodiments, the one or more tissue simulants 130 are formed from or comprise one or more materials selected from the group consisting of gel, hydrogel, transparent gel, ultrasound transparent gel, ballistic gel, crosslinked polymer, gelatinous substance, gelatin, silicone, polyurethane, liquid suspension, elastomer, plastic, and combinations thereof. In some embodiments, the one or more tissue simulants 130 comprises one or more layers of materials, or is formed from one or more layers of materials. In some embodiments, the one or more layers of materials comprise one or more properties selected from strength, hardness, ductility, density, weight, plasticity, flexural modulus, transparency, and the like. For example, the one or more layers of materials may comprise at least a first layer having at least a first property, and at least a second layer having at least a second property. Any number of layers of materials, in any order, having any number of properties, may be organized as the one or more tissue simulants 130 within container 102. In some embodiments, the top or most superficial layer of the one or more tissue simulants 130 is impregnated with an opaque dye or tint to obfuscate the location of the simulated vessels (e.g., one or more conduits 120). In some embodiments, the tinted or dyed one or more tissue simulants 130 obfuscates the locations of the simulated vessels requiring the use of an ultrasound probe (e.g., ultrasound probe 200 in FIG. 7). In some embodiments, the one or more tissue simulants 130 are dyed or tinted with one or more dyes or tints. In some embodiments, the layers of the one or more tissue simulants 130 may comprise different dyes, densities and hardnesses depending on the site, location, region or anatomical structure or landmark being modeled.

Aspects of the present invention relate to providing or supplying one or more blood simulants 140 to the one or more conduits 120 to simulate blood in the simulated vessels. In some embodiments, each conduit of one or more conduits 120 is at least partially fluidly filled with a fluid or one or more blood simulants 140. In some embodiments, the one or more blood simulants 140 are formed from or comprise one or more materials selected from the group consisting of artificial blood, water, dyed water, red dyed water. In some embodiments, the one or more blood simulants 140 can be provided by at least one blood simulant supply fluidly connected to the one or more conduits 120. In some embodiments, device 100 comprises at least one blood simulant supply connected to the first end 122 of the one or more conduits 120. In some embodiments, the at least one blood simulant supply is elevated from or positioned higher than container 102 in order to have blood simulant 140 flow into the one or more conduits 120. In some embodiments, the elevated position of blood simulant supply provides fluid pressure to the blood simulant in the one or more conduits 120. In some embodiments, device 100 further comprises any number of connector 180 and/or valve 180 connected to an end (e.g., second end 124) of the one or more conduits 120 (see FIG. 6). In some embodiments, the one or more blood simulants 140 provide a simulated blood flash upon needle cannulation of the vessel, to confirm accurate needle placement.

Aspects of the present invention relate to forming and/or positioning one or more anatomical simulants (e.g., simulated anatomical landmarks or structures) in device 100. In some embodiments, the one or more anatomical simulants are positioned in container 102 and/or tissue simulant 130 and configured to simulate one or more anatomical landmarks, regions and/or structures. In some embodiments, the one or more anatomical landmarks are selected from the group consisting of vascular landmarks, bony landmarks, soft tissue landmarks, muscular landmarks, bony structure, vasculature, vascular bifurcations/branches, soft tissue, soft tissue structures, echo-lucent soft tissue structures, ligamentous landmarks, inguinal ligament, the bifurcation of the common femoral artery, the femoral sheath, the bifurcation of the innominate artery into the subclavian, the brachiocephalic trunk, the pleural space, the clavicle, the ribs, the radius, the ulna, nerves, the brachial plexus nerves, lymph nodes, lymphatic structures, and any combinations thereof. In some embodiments, 3D printed echo-opaque structures are used to simulate bony structure. In some embodiments, echolucent soft tissue structures may be used for vascular bifurcations and/or branches. In some embodiments, heterogenous latex and other gel patterns simulate soft tissue and ligamentous landmarks.

Aspects of the present invention relate to providing feedback to a user of a successful and/or unsuccessful cannulation, procedure, treatment, and the like, using device 100. As detailed herein, the one or more blood simulants 140 may provide a simulated blood flash upon needle cannulation of the vessel, to confirm accurate needle placement. Other forms of feedback may be provided to the user including audio, visual, and haptic feedback when the user interacts with the one or more conduits 120 and/or one or more anatomical simulants positioned within device 100. Through the use of multiple densities of soft plastics, or different varieties of plastic, realistic tactile feedback will be generated as the needle access is passed through the soft tissue and into the lumen of the tubing, simulating the process of passing the needle into the lumen of the blood vessel. This combination of concomitant feedback modalities yields a more physiologically accurate training mode. The material choice in the layers selected yields a favorable amount of differential feedback to produce biomimetic tactile feel in the needles and dilators.

Aspects of the present invention relates to size, shapes and dimensions for device 100. In some embodiments, container 102 has a length ranging between 10 cm and 60 cm, a width ranging between 5 cm and 40 cm, and a height ranging between 5 cm and 20 cm. In some embodiments, container 102 has an interior volume ranging between 250 cm³ and 32,000 cm³. In some embodiments, container 102 is at least partially formed in one or more shapes, wherein the shapes are selected from the group consisting of oblong, rectangle, oval, square, circle, polygon, hexagon, octagon, and irregular.

Aspects of the present invention relate to a simulation kit comprising any number of disclosed simulation device (e.g., device 100). In some embodiments, the simulation kit comprises a device 100 having one or more compartments 160 with one or more endovascular tools positioned in the compartments and a blood simulant supply. In some embodiments, the one or more endovascular tools are selected from the group consisting of needles, vascular access needles, cannula, ECMO cannula, catheter, guide wire, pump, balloon and dilator. In some embodiments, the kit further comprises any of: a tissue simulant supply, tissue simulant precursors, a tissue simulant, a gel insert, one or more valves, one or more connectors, and one or more syringes. For example, connector 180, valve 184, and/or catheter 190, and/or cannula 192 (e.g., ECMO cannulae) as shown in FIG. 6, or syringe 186 of FIG. 7. It should be appreciated that any disclosed connectors, valves, syringes and/or cannula are compatible with industry standard endovascular tools, cannula devices and IV equipment. In some embodiments, the kit may include any number or an assortment of anatomical landmarks representative of common regions in a subject and instructions for configuration of the common regions using the kit and device.

Aspects of the present invention relate to a method of fabricating or assembling a simulation device (e.g., device 100). In some embodiments, the method of fabricating a simulation device 100 comprises the steps of providing a container 102 comprising a base 108 with one or more sidewalls 110 extending upwards from the base 108 forming a top opening 112, and one or more holes or openings 114 passing through at least one of the sidewalls 110, providing one or more conduits 120 each having first and second ends (122, 124), wherein the one or more conduits 120 are formed from at least one flexible and puncturable material, positioning the one or more conduits 120 to at least partially pass through the container 102 with at least one end extending out through at least one of the one or more openings 114, configuring the one or more conduits 120 to simulate one or more blood vessels, at least partially filling the container 102 with one or more tissue simulants 130, and at least partially filling at least one of the one or more conduits 120 with a blood simulant.

In some embodiments, the step of configuring the one or more conduits 120 to simulate one or more blood vessels comprises sizing, shaping, fixing, positioning, and/or arranging the one or more conduits 120 in container 102 and/or tissue simulant 130 during the fabrication process of the device (e.g. during the step of filling the container with one or more tissue simulant). In some embodiments, the step of configuring the one or more conduits comprises the steps of providing one or more shaping structures configured to removably reside within the one or more conduits during the step of filling the container and/or shaping the one or more conduits to simulate one or more blood vessels. In some embodiments, the step of providing one or more conduits comprises 3D printing the one or more conduits in the size and shape of one or more blood vessels. In some embodiments, the method further comprises placing one or more anatomical simulants, landmarks and/or structures in the container during the step of filling the container.

In some embodiments, the method of fabricating or assembling a simulation device comprises providing one or more fluid supplies (e.g., blood simulant supply) fluidly connected to the one or more conduits 120. In some embodiments, the method further comprises providing and/or positioning one or more anatomical landmarks or features in tissue simulant 130 and/or container 102. In some embodiments, the method comprises connecting a fluid supply to at least one end (e.g., first end 122) of the one or more conduits 120, and connecting a syringe (e.g., syringe 186) with other attachments (connectors 180, valves 184) to another end (e.g., second end 124).

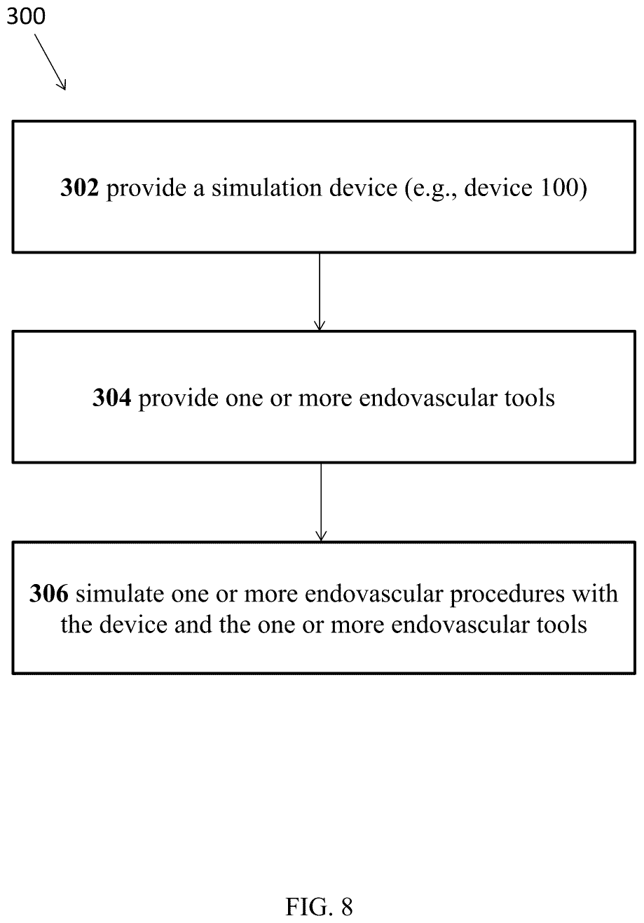

Aspects of the present invention relate to a method of use for the disclosed simulation device or a method of simulating an endovascular procedure. The methods described herein provide for training of healthcare personnel and trainees to perform endovascular procedures. Referring now to FIG. 8, shown is an exemplary method 300 of simulating an endovascular procedure according to aspects of the present invention. In some embodiments, method 300 comprises the steps of: 302 providing a simulation device (e.g., device 100), 304 providing one or more endovascular tools, and 306 simulating one or more endovascular procedures with the device and the one or more endovascular tools. In some embodiments, the step of simulating one or more endovascular procedures comprises the steps of identifying the one or more simulated blood vessels; and cannulating the one or more simulated blood vessels with the one or more endovascular tools. In some embodiments, device 100 may be used with an ultrasound probe 200 (shown in FIG. 7) during any simulated procedures.

In some embodiments, the method further comprises the step of advancing one or more guidewires or dilators into the one or more simulated blood vessels. In some embodiments, the cannulating step comprises advancing fully one or more extracorporeal membrane oxygenation (ECMO) cannula into the appropriate one or more simulated blood vessels, with differential inner and outer diameters between the simulated vein and artery.

In some embodiments, the one or more vascular procedures comprise any of venous cannulation, arterial cannulation, ECMO cannulation, vein or vessel access procedures, vein or vessel dilation procedures, vein or vessel identification procedures (e.g., the Seldinger technique), Impella placement, intra-aortic balloon pump placement, atherectomy, angioplasty, stenting, thrombolysis, valvuloplasty, transcatheter aortic valve replacement (TAVR) or other transcatheter valve interventions, patent foramen ovale (PFO), transcarotid artery revascularization (TCAR). The disclosed devices, kits and methods function as a training tool for simulating one or more procedures. The devices, kits and methods may be used and/or performed by one or more users manually (e.g., by hand) but also may be used with or by any robotic surgical systems known in the art for training on the respective system. This includes using the devices, kits and methods with various end effectors and tools used in robotic surgical systems. It should be appreciated that the devices, kits and methods may also comprise any aspects of robotic surgical systems, and may be used in conjunction with any user interfaces thereof.

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### CannuSim: An ECMO Cannulation Simulation Tool

Disclosed herein is an exemplary simulation device and method referred to in some examples as “CannuSim”. The CannuSim is a simulation tool or device designed to recreate the process of accessing blood vessels, dilating, and ultimately cannulating large arteries and veins with extracorporeal membrane oxygenation (ECMO) cannulae. This process is achieved in subjects (e.g., patients) using the Seldinger technique, which requires ultrasound identification of the vessels of interest, needle cannulation, and advancing of multiple dilators over a guide wire to allow the introduction of large bore ECMO cannulae into the relevant vessels. The disclosed simulation device allows trainees and experienced clinicians alike to practice the relevant technical skills of this procedure, allowing ultrasound identification of vessels, and landmarks placed in the ultrasound transparent gel. In some embodiments, the disclosed simulation device provides a simulated blood flash upon needle cannulation of the vessel, to confirm accurate needle placement. In some embodiments, the device allows advancing of guide wires, dilators, and ultimately full diameter ECMO cannulae with high fidelity tactile feedback to end users. In some embodiments, the device allows complete lengthwise advancement of ECMO cannulae into the simulated vessel, unlike other devices or models.

While this examples relates to an exemplary method developed for ECMO cannulae, other relevant cannulae or endovascular tools can be adapted to work with the disclosed device, allowing training for interventional cardiology (obtaining vascular access, Impella placement, intra-aortic balloon pump placements for example), vascular surgery (endovascular access), and members of the ICU, medicine, and pre-hospital community (in the placement of central lines and other vascular access). Due to the device's adaptable nature and ability to add or remove landmarks, the device can be used to simulate a large number of vessels above and beyond just femoral vein and artery access, including subclavian, jugular, or other vessels. In some embodiments, relevant bony, vascular, or soft tissue landmarks can be added or removed as necessary, including vascular bifurcations, and ligaments, meaning that this device can be used by a wide variety of departments, specialties, and centers, not just ECMO centers.

The CannuSim addresses the acute need for repeated practice with the tactile, hands on steps associated with large vessel cannulation. This device allows personnel (e.g., providers) to practice the mechanical and technical skills of performing vessel cannulation under sterile conditions without fear of contaminating the subject. In some embodiments, the disclosed device provides a small-scale model of arteries and veins for vessel identification and needle access that is not limited in size and ability to be cannulated. In some embodiments, the device allows large diameter cannulae, and features anatomical landmarks. In some embodiments, the disclosed device may be integrated with additional simulation devices such as humanoid manikins. In some embodiments, the device allows trainees to repeat the necessary repetitions of tactile, hands on procedures before moving to subject (e.g., live patients). In some embodiments, the disclosed device offers high-fidelity tactile feedback of central vessel cannulation allowing repeated simulation and development of hands on practical experience and clinical judgment prior to initiating ECMO support in live patients. In some embodiments, the device allows the various team members including doctors and nurses, to practice the procedure together and debrief to improve efficiency and safety in the future.

FIGS. 1-4 depict an exemplary simulation device comprising a shell or container having one or more conduits passing through the container, which is ultimately filled with gel (see FIG. 5). In some embodiments, the device comprises one or more removable side compartments (see FIG. 6). In some embodiments, the device is used for simulating and/or training ECMO cannulation (see FIG. 7). The disclosed device underwent multiple phases of prototyping, validation with real ECMO cannulae, and hands on testing with cardiac surgery residents, attending physicians, and advanced practice providers, all of whom reported a high degree of realism, and tactile feedback, with many indicating a desire to use this device again.

The steps of forming and/or assembling an exemplary simulation device are discussed herein. First, an exemplary design for a shell or container was formed (e.g., 3D printed). The disclosed design of the shell has been designed to be robust for both fused deposition (FDM) and resin printers. In some embodiments, a high 3D printing infill percentage improves both durability of the shell and the resistance to heat from the hot gel as it is poured. In some embodiments, the device can be scaled to larger or smaller sizes, and deeper or shallower depths. Once the shell is printed, a mix of 10% and 20% ballistic gel was prepared for pouring in to, and at least partially filling the shell. In the disclosed example, both 10% and 20% mix were tested and it was found that somewhere in the middle of these values provides a gel with the highest quality and most realistic tactile feedback for trainees. The gel was melted per the manufacturer's instructions to start, but was then heated past the recommended upper limit. In some embodiments, this step is critical for ensuring the gel is still a liquid throughout the pour and settling process, even as it cools in the air. It was found that normal heating temps work for molding the gel crudely, however it may introduce bubbles that would compromise the ultrasound compatibility of the poured gel.

This extra heat also enables larger pours of gel, reducing the number of layer lines, which are visible on ultrasound in the gel after cooling. Layers are necessary when the pouring temperature of the gel is above the glass transition temperature of the material (e.g., plastic 3D printer filament) used in the shell. If the entire amount of gel was poured at once, the dimensional integrity of the shell may be compromised preventing integration with the other parts of the device. Because the gel is poured in layers, it is possible to remove imperfections in the gel pours as the layers are added. Because these layers of gel are clear, it is easy to identify and repair these imperfections. Eliminating these bubble imperfections gives not only good visualization of the vessel, but also the surrounding “tissue.” When forming an exemplary prototype of the disclosed device (see FIG. 5), care was taken to ensure fidelity of each of these steps preserving ultrasound image quality through multiple layers of gel, and attaining appropriate tactile feedback on vessel cannulation.

Once the shell was filled to the bottom of the tubing holes or openings, C-clamps were placed around the tubing to seal the mold. The C-clamps are later removed. The C-clamps allow the gel to remain contained in the housing but once removed, allows the tubing to expand to accommodate the cannulas. Next, both the space between both tubes and the space outside the tubes were filled in one pour before the gel has fully cooled. This is integral as filling each of the 3 sub-areas separately pushes the tubes to the side, and deforms the vessel anatomy, reducing the reliability of the device or model. It is important to stop the pour at the top of the tubes, however, as if too much weight, or heat was added, the tubes may become deformed or collapse. Once that layer is cooled, additional layers can be poured on top in the same fashion as the lower layers.

Lastly, when nearing the top of the mold, a powder based pigment was mixed into the melting gel. It is critical that this be a dry powder, as many liquid dyes/coloring will boil when added to the hot gel and either discolor, or make the gel difficult to work with. Adding the powder pigment to gel still introduces bubbles, but fewer than liquid dyers. As a result, it is important to continue heating above the manufacturer recommended specs for a prolonged period while mixing to ensure homogeneity of the dye, and dissolving of the bubbles. Any remaining bubbles on the surface of the gel can be obliterated by heating just the surface of the gel. For example, in some embodiments, the surface of the gel can be re-melted and smoothed to further clarify/perfect the surface once poured similar to reflowing solder.

Once the gel is a satisfactory color, and free of bubbles, the top layer can be poured. It is important to slightly overfill the shell and even allow a bit of gel to spill over down the side of the mold. This extra material facilitates post-pour smoothing. Once the top layer cools, the drippings can be trimmed off (like a candle wax). This, however, leaves unsightly edges. This can be rectified with a heat gun. Using the heat gun locally to pop any bubbles that may have formed near the surface is effective, and particularly effective at re-smoothing edges at the sites of the trimmed drips. This allows a meniscus of gel to form on top of the mold without compromising the ultrasound transparency without damaging the shell, or introducing bubbles. The resulting surface is smooth, skin like, free of bubbles, ultrasound transparent, and opaque, obfuscating the location of the vessels, which forces trainees to use their ultrasound skills.

The gel was then cooled for a period of time (e.g., one day). The gel may be allowed to cool in ambient temperatures, or may be cooled. When the gel was cooled, the C-clamps around the vessels were removed. The gel will not leak at this point, but the vessel will be free to expand as they pass through the external shell dilated by cannulas. Similarly, at this time, Luer locks can be attached to the tubing ends allowing fluid to be introduced into the lumen of the vessels. It is important the vessels be completely dry, with open ends during the pour to prevent steam buildup, and allow cool air to pass through the lumen to prevent deformation. Thus the insertion of the Luer locks after the gel cools is essential. In some embodiments, the Luer locks can be secured with CA glue.

The disclosed device is more portable than other devices, and can be reused, as the gel self closes over the site of the cannulation. Furthermore, the gel selected is impervious to ultrasound jelly, thus further making the gel (in some examples referred to as a tissue insert) more reusable. The disclosed assembly steps produce a high fidelity model, allowing the capture of high quality imaging (e.g., ultrasound). This combination allows healthcare personnel and trainees to practice performing and integrating the key steps of ECMO cannulation in one setting.

Once the device is completed and fit for use, an IV bag with fluid of the users' choosing is attached to IV tubing, often with flow rate control. This in turn is attached via Luer lock mechanism to the tubing. The IV bag is placed at a height higher than the device and the flow is set to the desired rate. This allows for pressurized flow of fluid when the vessel is entered with a needle/catheter/dilator/cannula without the need for a pump.

Once the device has been used, the user will remove the cannulas. The tubing is largely self sealing and can be used multiple times. In this example the tubing was penetrated 7 times without leakage of fluid through the gel. The tubes may be emptied of their liquid by using a syringe on the Luer lock mechanism and aspirating until no fluid remains. The long tubing can be wrapped around tube organizer on the bottom of the shell. The device is now ready for the next use.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A simulation device comprising:
a container having a first end and a second end comprising a base with one or more sidewalls extending upwards from the base forming a top opening, and one or more openings passing through at least one of the sidewalls;
one or more conduits each having a first end and a second end configured to simulate one or more blood vessels, wherein each conduit extends from the first end of the container to the second end of the container, and wherein a portion of at least one end of each conduit extends out from the container through the one or more openings;
wherein the container is at least partially filled with one or more tissue simulants, and at least one of the one or more conduits are at least partially filled with a blood simulant.

2. The device of claim 1, wherein the one or more blood vessels are selected from the group consisting of: femoral artery, femoral vein, subclavian artery, subclavian vein, jugular vein, radial artery, axillary artery, and carotid artery.

3. The device of claim 1, wherein the one or more conduits comprise a first conduit and a second conduit, wherein the first conduit has a diameter that is different from a diameter of the second conduit.

4. The device of claim 1, wherein the one or more conduits comprise a first conduit configured to simulate a femoral artery, and a second conduit configured to simulate a femoral vein.

5. The device of claim 1, further comprising one or more anatomical simulants positioned in the container configured to simulate one or more anatomical landmarks.

6. The device of claim 5, wherein the one or more anatomical landmarks are selected from the group consisting of: vascular landmarks, bony landmarks, soft tissue landmarks, muscular landmarks, bony structure, vasculature, vascular bifurcations/branches, soft tissue, soft tissue structures, echo-lucent soft tissue structures, ligamentous landmarks, inguinal ligament, the bifurcation of the common femoral artery, the femoral sheath, the bifurcation of the innominate artery into the subclavian, the brachiocephalic trunk, the pleural space, the clavicle, the ribs, the radius, the ulna, nerves, the brachial plexus nerves, lymph nodes, and lymphatic structures.

7. The device of claim 1, wherein the one or more tissue simulants are selected from the group consisting of gel, hydrogel, transparent gel, ultrasound transparent gel, ballistic gel, crosslinked polymer, gelatinous substance, gelatin, silicone, polyurethane, liquid suspension, and elastomer.

8. The device of claim 1, wherein the one or more tissue simulants are dyed or tinted with one or more dyes or tints.

9. The device of claim 1, wherein the blood simulant is selected from the group consisting of artificial blood, water, dyed water, red dyed water.

10. The device of claim 1, wherein the one or more conduits comprise a flexible and puncturable tubing formed from one or more materials selected from the group consisting of: polymer, latex, rubber, silicone, silicone rubber, thermoplastic elastomer (TPE), thermoplastic polyurethane (TPU), continuous liquid interface production (CLIP) resin, and 3D printed material.

11. The device of claim 1, further comprising at least one blood simulant supply connected to the first end of the one or more conduits.

12. The device of claim 11, further comprising a syringe or valve connected to the second end of the one or more conduits.

13. A simulation kit, comprising:
the device of claim 1;
one or more endovascular tools; and
a blood simulant supply.

14. The kit of claim 13, wherein the one or more endovascular tools are selected from the group consisting of needle, cannula, ECMO cannula, catheter, guide wire, pump, balloon and dilator.

15. The kit of claim 13, further comprising at least one of a tissue simulant supply, one or more valves, one or more connectors, vascular access needles, and one or more syringes.

16. A method of simulating an endovascular procedure, comprising the steps of:
providing the device of claim 1;
providing one or more endovascular tools;
simulating one or more endovascular procedures with the device and the one or more endovascular tools.

17. The method of claim 16, wherein the step of simulating one or more endovascular procedures comprises the steps of:
identifying the one or more simulated blood vessels; and
cannulating the one or more simulated blood vessels with the one or more endovascular tools.

18. The method of claim 17, further comprising the step of advancing one or more guidewires or dilators into the one or more simulated blood vessels.

19. The method of claim 17, wherein the cannulating step comprises advancing fully one or more extracorporeal membrane oxygenation (ECMO) cannula into the appropriate one or more simulated blood vessels.

20. A method of fabricating a device comprising the steps of:
providing a container comprising a base with one or more sidewalls extending upwards from the base forming a top opening, and one or more holes passing through at least one of the sidewalls;
providing one or more conduits having first end and a second end, wherein the one or more conduits are formed from at least one flexible and puncturable material;
positioning the one or more conduits to pass through the container with at least one end extending out through at least one of the one or more holes;
configuring the one or more conduits to simulate one or more blood vessels;
filling the container at least partially with one or more tissue simulants;
filling the one or more conduits with a blood simulant.
